(19) United States
(12) Patent Application Publication
(10) Pub. No.: US 2026/0230879 A1
(43) Pub. Date: Aug. 6, 2026

(54) METHODS, ARCHITECTURES, APPARATUSES AND SYSTEMS FOR MAINTAINING CONSISTENT SENSING MEASUREMENTS

(71) Applicant: InterDigital Patent Holdings, Inc., Wilmington, DE (US)

(72) Inventors: Fumihiro Hasegawa, Westmount (CA); Jongwoo Hong, New York, NY (US); Ghyslain Pelletier, Montreal (CA); Remun Koirala, London (GB); Moon IL Lee, Melville, NY (US); Arman Shojaeifard, London (GB); Kevin Wanuga, Souderton, PA (US); Paul Marinier, Brossard (CA); Benoit Pelletier, Roxboro (CA)

(21) Appl. No.: 19/044,572

(22) Filed: Feb. 3, 2025

(51) Int. Cl. H04W 24/10; H04L 5/00; H04W 24/08

(52) U.S. Cl. CPC H04W 24/10; H04L 5/0048; H04W 24/08

(57) ABSTRACT

Wireless transmit/receive unit (WTRU) methods and systems are provided for sensing and communications. The WTRU, methods, and systems include receiving, from a wireless network, sensing configuration information for performing one or more measurements of a reference signal, determining a condition indicator based on a change in a condition of the WTRU or a sensing target, and performing one or more measurements of the reference signal based on the sensing configuration information. Additionally, the WTRU, methods, and systems include transmitting, to the wireless network, a measurement report indicating the one or more measurements of the reference signal, and the condition indicator.

### BACKGROUND

The present disclosure is generally directed to the fields of communications, software and coding, including, for example, to methods, architectures, apparatuses, systems related to sensing and communications.

A device (e.g., a user equipment or a wireless transmit/receive unit) that is communicatively coupled to a wireless network may perform sensing-related measurements based on signals from the wireless network, and inconsistencies in the measurement environment can lead to inaccurate results.

### SUMMARY

For network-based sensing, the wireless network may collect measurements from wireless transmit/receive units (WTRUs) and process (e.g., average) them. The WTRUs may rotate or move when performing measurements. Unexpected incidents may happen on the WTRU side without knowledge of the wireless network (e.g., a power outage, or blockage). In some examples, the WTRU may not report location information to the next generation node B(gNB). The WTRU may report quantities (e.g., measurements, post-processed measurements, or a condition indicator) as a function of the determination of a change in one or more WTRU-side conditions (e.g., position, rotation, angular reception, channel state conditions, signal processing consistency, and implementation-based inconsistency detection). If measurements are performed inconsistently, processed measurements may result in inaccurate results. The WTRU may report measurements based on the determined condition indicator. By using an indication of a change in the condition of the WTRU and/or sensing target received from the WTRU, the wireless network is enabled to determine whether to process (e.g., average) the reported measurements to determine a location of the sensing target. The wireless network may obtain accurate information of the location of the sensing target by averaging or processing the performed measurements.

The WTRU methods and systems provided herein include receiving, from the wireless network, sensing configuration information for performing one or more measurements of a reference signal (RS), determining a condition indicator based on a change in a condition of the WTRU or a sensing target, and performing one or more measurements of the reference signal based on the sensing configuration information. In some embodiments, the condition indicator is a bit value. In some embodiments, the WTRU determines the condition indicator based on a change in more than one condition of the WTRU and/or the sensing target. Additionally, the WTRU is configured to transmit, to the wireless network, a measurement report indicating the performed measurements of the reference signal, and the condition indicator.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows an illustrative graph of example channel impulse response (CIR) estimate, in accordance with one or more embodiments of the present disclosure;

FIG. 3 shows an illustrative example of a WTRU and wireless network showing a spatial relationship between a down-link (DL) signal and an up-link reference signal (UL-RS) that may be used within the communications system illustrated in FIG. 1A;

FIG. 4 shows an illustrative graph of an example multi-path delay profile, in accordance with one or more embodiments of the present disclosure;

FIGS. 5A-B show examples of WTRU report content, in accordance with one or more embodiments of the present disclosure;

FIG. 6 shows an illustrative graph of example paths associated to sample-based measurements, in accordance with one or more embodiments of the present disclosure;

FIG. 7 shows an illustrative example of a WTRU and wireless network using a condition indicator over a time period, in accordance with one or more embodiments of the present disclosure;

FIG. 8 shows an illustrative example of a WTRU and wireless network using timestamps to indicate a change in a condition of the WTRU or sensing target, in accordance with one or more embodiments of the present disclosure;

FIG. 9 shows an illustrative example of a WTRU and a gNB communicating messages that may be used within the communications system illustrated in FIG. 1A, in accordance with one or more embodiments of the present disclosure; and

FIG. 10 shows a flowchart of a process performed by a WTRU for maintaining consistent sensing measurements, in accordance with one or more embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

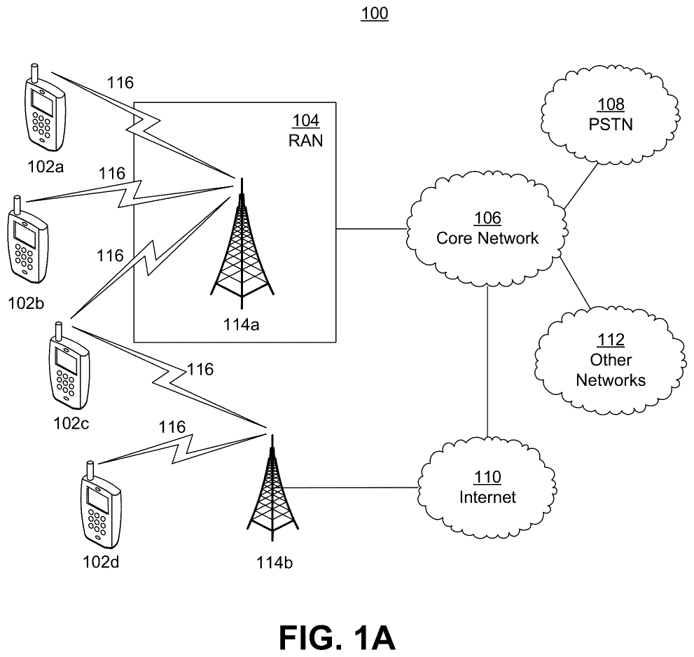

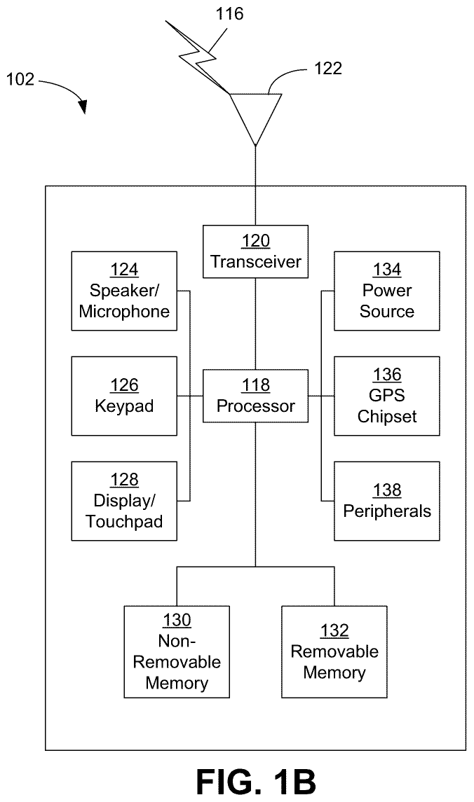

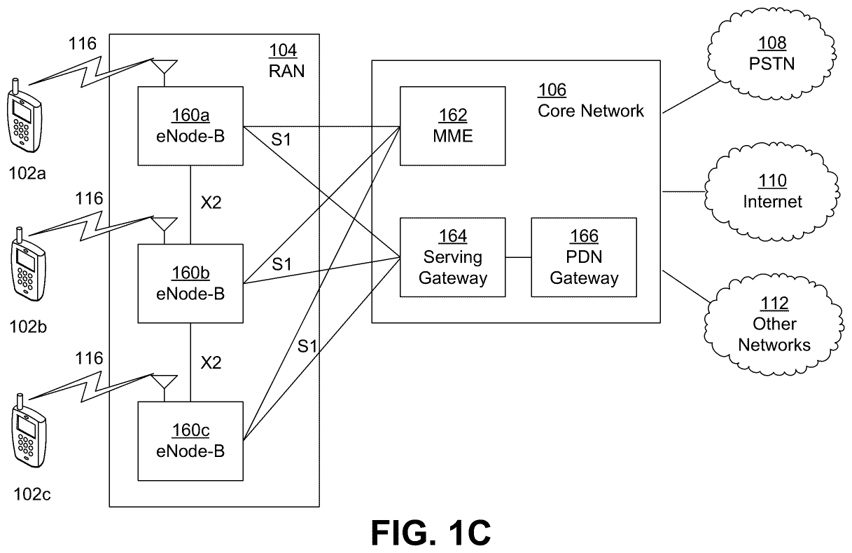

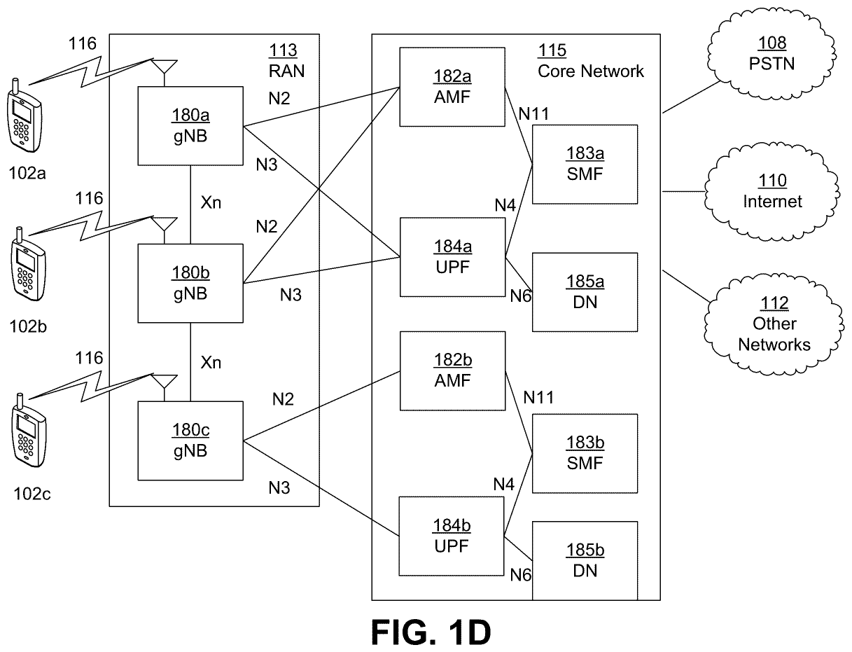

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

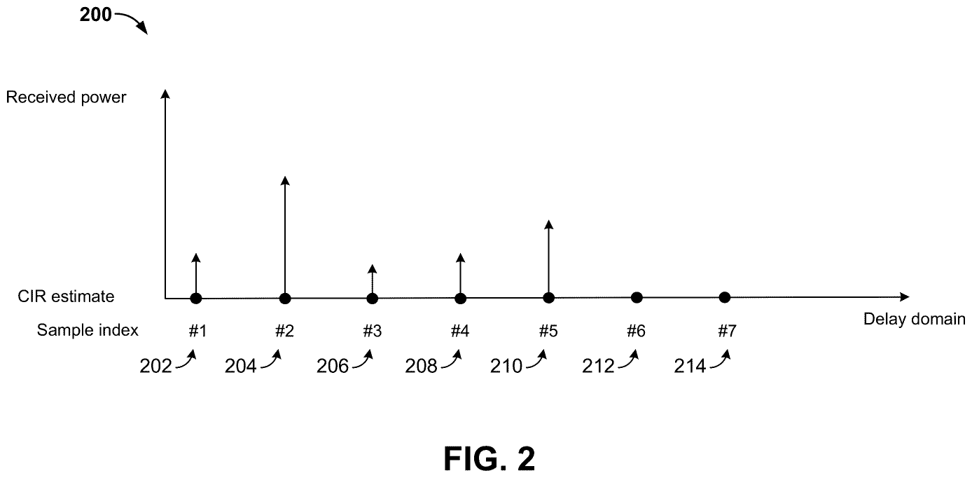

In certain embodiments of the present disclosure, including those described below at least in connection with FIGS. 2-10, the devices, systems, architectures, communication links, apparatuses, and other elements depicted in FIGS. 1A-1D may be used in connection with sensing and the reporting of a measurement report.

### WTRU Behavior

The WTRU may send a request to the wireless network for a configuration (e.g., down-link reference signal (DL-RS) configurations, up-link reference signal (UL-RS) configurations) in Physical Uplink Shared Channel (PUSCH), Physical Uplink Control Channel (PUCCH), Uplink Control Information (UCI), medium access control-control element (MAC-CE), radio resource control (RRC) or LTE positioning protocol (LPP) message. The request from the WTRU may include configurations of, for example, a measurement gap, DL-RS processing window, or window for transmission of UL-RSs.

The WTRU may send an acknowledgment message (e.g., in PUSCH or PUCCH) for the grant message received from the wireless network. The WTRU may be configured with more than one condition and associated WTRU behavior. The WTRU may determine which WTRU behavior the WTRU uses based on an applicable condition. In some embodiments, more than one condition or criterion can be used in combination thereof.

The WTRU may measure DL inside or outside of an active bandwidth part (BWP). In some embodiments, the WTRU may transmit UL-RS inside or outside of the active BWP. The WTRU may be preconfigured with parameters (e.g., measurement gaps, DL-RS processing windows, DL-RS configurations, or UL-RS configurations) via a semi-static message (e.g., LPP or RRC). In some embodiments, any actions the WTRU determines to take may be configured by the wireless network. For example, the WTRU may be configured with a rule, in accordance with the WTRU may determine to take an associated action. In addition to the measurements made on DL-RS, the WTRU may include at least one of the following cell-related measurements: (1) synchronization signal burst (SSB) reference signal received power (RSRP) from the serving cell with corresponding cell ID, (2) SSB RSRP from one or more neighboring cells with corresponding cell IDs, (3) RSRP of channel state information-reference signal (CSI-RS) with CSI-RS resource ID, or (4) RSRP of demodulation-reference signal (DM-RS).

### Terminology

Hereinafter, the term “network” may correspond to a function, node and/or a protocol that terminates in the radio access (e.g., gNB, next-generation RAN (NG-RAN)) entity or in the core network (e.g., access mobility management function (AMF), location management function (LMF)) data collection function or any other suitable function. The terms “pre-configuration” and “configuration” may be used interchangeably. The terms “non-serving gNB” and “neighboring gNB” may be used interchangeably. The terms “gNB” and “transmission reception point (TRP)” may be used interchangeably. The terms “DL-RS” or “DL-RS resource” may be used interchangeably. The terms “DL-RS (s)” or “DL-RS resource(s)” may be used interchangeably. In some embodiments, the aforementioned “DL-RS(s)” or “DL-RS resource(s)” may belong to different DL-RS resource sets. The terms “measurement gap” or “measurement gap pattern” may be used interchangeably. A “measurement gap pattern” may include parameters such as measurement gap duration, measurement gap repetition period, or measurement gap periodicity.

An LMF may be a non-limiting example of a node or entity (e.g., network node or entity) that may be used for or to support positioning or sensing. In some embodiments, any other node or entity may be substituted for the LMF in accordance with the present disclosure. In some embodiments, the WTRU may receive one or more preconfigured thresholds from the wireless network (e.g., LMF, gNB). In some implementations, a line-of-sight (LOS) indicator may be a hard indicator (e.g., 1 or 0) or a soft indicator (e.g., 0, 0.1, 0.2 . . . , 1). The LOS indicator may indicate a likelihood of the presence of an LOS path (a) between a TRP and the WTRU or (b) along a DL-RS. The LOS indicator may be associated with a TRP or positioning reference signal (PRS) resource ID (e.g., an index). In some embodiments, the WTRU may receive a LOS indicator from the network for each TRP or PRS resource ID. In alternative implementations, the WTRU may determine the LOS indicator for each TRP or PRS resource ID based on measurements performed by the WTRU. In the examples described herein, “ID” and “index” may be used interchangeably.

A WTRU location may be expressed in terms of altitude, latitude, geographic coordinate, local coordinate, or using any other suitable way to indicate position or location. In the examples described herein, a timestamp may be indicated by an absolute time, relative time (e.g., in seconds) compared to a reference time, system frame number (SFN), slot index, frame index, subframe index and/or symbol index. Examples of “absolute time” may be universal time coordinated (UTC) time, global navigation satellite system (GNSS) time, or locally-defined absolute time (e.g., LTE or NR Time).

In the examples described herein, the WTRU may receive configurations for a time window, which may include: (a) a duration (e.g., expressed in terms of seconds, number of symbols, number of slots, number of frames, or number of subframes), and (b) a start and/or end time (e.g., expressed in terms of absolute time, system time, relative time with respect to a reference time indicated by the wireless network or determined by the WTRU, SFN index, slot index, symbol index, frame index, or subframe index). The WTRU may receive more than one configuration of a time window where each configuration is associated with an index. The time window may be initiated by receiving a trigger signal sent from the wireless network. For example, the WTRU may receive a command (e.g., downlink control information (DCI)) to initiate a time window associated with a corresponding configuration index. The WTRU may determine to initiate the time window after a (e.g., configured) period of time (e.g., N symbols, N slots, N frames, N seconds) after receiving the command (e.g., the DCI). In some embodiments, the WTRU may receive, from the wireless network, an activation command or deactivation command (e.g., DCI, MAC-CE) to activate or deactivate the time window, respectively.

### Configurations for RSs

In some embodiments, the WTRU may receive, from the wireless network (e.g., the LMF), sounding reference signal (SRS) configurations (e.g., DL-RS and/or UL-RS configurations) to determine the position of the WTRU. The LMF may forward a PRS configuration and the SRS configurations to the gNB such that the gNB schedules PRS transmission or SRS reception at one or more of the TRP, transmission point (TP), and reception point (RP).

In some embodiments, a DL-RS configuration may include at least one of the following parameters: (1) a number of symbols, (2) transmission power, (3) a number of DL-RS resources included in a DL-RS resource set, (4) a muting pattern for DL-RS (e.g., a bitmap indicative of the muting pattern), (5) a periodicity, (6) a type of DL-RS (e.g., periodic DL-RS, semi-persistent DL-RS, or aperiodic DL-RS), (7) a slot offset for periodic transmission for DL-RS, (8) a vertical shift of DL-RS pattern in the frequency domain, (9) a time gap during repetition, (10) a repetition factor, (11) a resource element (RE) offset, (12) comb pattern, (13) comb size, (14) a spatial relation (e.g., with respect to other DL-RSs or UL-RS such as SRS for positioning purposes), (15) quasi co-location (QCL) information (e.g., QCL target, QCL source) for DL-RS, (16) a number of TRPs, (17) an Absolute Radio-Frequency Channel Number (ARFCN), (18) subcarrier spacing, (19) an expected reference signal time difference (RSTD), (20) an uncertainty in expected RSTD, (21) a start Physical Resource Block (PRB), (22) bandwidth, (23) BWP ID, (24) a number of frequency layers, (25) a start and/or end time for DL-RS transmission, (26) an on/off indicator for DL-RS, (27) a TRP ID, (28) a DL-RS ID, (29) a cell ID, (30) a global cell ID, and (31) an applicable time window. In some embodiments, the WTRU may apply a DL-RS configuration within the applicable time window. As described herein, the term “ID” may be used interchangeably with “index”. Some examples of a DL-RS are channel state information reference signal (CSI-RS), phase tracking reference signal (PTRS), PRS, tracking reference signal (TRS), and SSB.

In some embodiments, the UL-RS configuration or SRS configuration may include at least one of: (1) a resource ID; (2) comb offset values or cyclic shift values; (3) a start position in the frequency domain; (4) a number of UL-RS symbols; (5) a shift in the frequency domain for UL-RS; (6) a frequency hopping pattern; (7) a type of UL-RS (e.g., aperiodic UL-RS, semi-persistent UL-RS, or periodic UL-RS); (8) a sequence ID used to generate UL-RS, or other IDs used to generate a UL-RS sequence; (9) spatial relation information, indicating which reference signal (e.g., DL-RS, UL-RS, CSI-RS, SRS, DM-RS) or an SSB (e.g., SSB ID or cell ID of the SSB) to which the UL-RS is spatially related, where the UL-RS and DL-RS may be aligned spatially; (10) QCL information (e.g., a QCL relationship between UL-RS and other reference signals or SSB); (11) a QCL type (e.g., QCL type A, QCL type B, QCL type C, or QCL type D); (12) a resource set ID; (13) a list of UL-RS resources in the resource set; (14) transmission power related information; (15) pathloss reference information which may contain an index for an SSB, CSI-RS or DL-RS; (16) a periodicity of UL-RS transmission; and/or (17) spatial information such as spatial direction information of UL-RS transmission (e.g., beam information or angles of transmission), spatial direction information of DL-RS reception (e.g., a beam ID used to receive the DL-RS, or angle of arrival (AoA)). Some examples of UL-RS include SRS and SRS for positioning purposes.

In 3GPP, the following categories of WTRU positioning techniques are specified: (a) DL positioning method, (b) UL positioning method, and (c) DL & UL positioning method. A “DL positioning method” may refer to any positioning method that uses DL-RSs such as PRSs. In some embodiments, the WTRU receives multiple RSs from one or more TPs and measures DL RSTD and/or RSRP. Some examples of DL positioning methods are DL angle of departure (DL-AoD) or DL time difference of arrival (DL-TDOA) positioning. A “UL positioning method” may refer to any positioning method that uses UL-RSs such as SRS for positioning. In some embodiments, the WTRU transmits SRS to multiple RPs and the RPs measure the UL relative time of arrival (RTOA) and/or RSRP. Some examples of UL positioning methods are UL-TDOA or UL-AoA positioning. A “DL & UL positioning method” may refer to any positioning method that uses UL-RSs and DL-RSs for positioning purposes. In one example, a WTRU transmits SRS to multiple TRPs and a gNB measures a receive-to-transmit (Rx-Tx) time difference, which is calculated based on a time of arrival of a DL-RS (e.g., PRS). In some embodiments, the gNB may measure RSRP for the received SRS. In some embodiments, the WTRU measures the Rx-Tx time difference for a PRS transmitted from multiple TRPs. In addition, the WTRU may measure RSRP for the received PRS. The Rx-Tx difference and RSRP measured at the WTRU and the gNB may be used to calculate a round trip time (RTT). The term “WTRU Rx-Tx time difference” may refer to the difference between the arrival time of the RS transmitted by the TRP and the transmission time of the RS transmitted from the WTRU. One example of a DL & UL positioning method is multi-RTT positioning.

In one example, the WTRU may obtain a CIR (Channel Impulse Response) from the wireless network. The wireless network may indicate, to the WTRU, one or more DL-RS configurations such as DL-RS resource IDs associated with the CIR. For example, the CIR may be associated with a DL-RS resource ID. In such an example, the WTRU may determine that the CIR is based on the measurements made using the DL-RS resource associated with the ID. Alternatively, the WTRU may determine that the channel along the direction of (a) transmission of the DL-RS or (b) reception of the DL-RS, corresponds to the CIR.

In another example, the CIR may be associated with a TRP ID. In some embodiments, the WTRU may determine that the CIR represents the channel between an associated TRP and WTRU. In further examples, the CIR may be associated with more than one TRP, where the wireless network may include TRP indices associated with the CIR.

In some embodiments, the CIR may be associated with a cell. In such embodiments, the WTRU may receive a cell ID or index associated with the CIR from the wireless network. In other embodiments, the CIR may be associated with more than one TRP or DL-RS resource ID. In such embodiments, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In another example, more than one CIR may be associated with one parameter from DL-RS configurations (e.g., a TRP ID, a DL-RS resource ID, or a frequency layer ID). For example, the WTRU may receive, from the wireless network, information related to two CIRs associated with a TRP. Alternatively, the WTRU may report, to the wireless network, information related to more than one CIR associated with a parameter of the DL-RS configuration (e.g., a TRP ID or a DL-RS resource ID) based on measurements. There may be more than one CIR associated with a DL-RS configuration since the WTRU or wireless network may observe different channel characteristics based on the AoA of the DL-RS or the UL RS, for example.

A CIR may be represented by a delay profile (DP) or a power delay profile (PDP). A PDP may be defined as a set of delays and power profiles, such as [τ₀, τ₁, . . . , τ_{N-1}] and [p₀, p₁, . . . , p_{N-1}], where pₖ corresponds to a relative power at the k^{th} path compared to the first path. A delay profile may be defined as a set of delays [τ₀, τ₁, . . . , τ_{N-1}], for a reference timing, which may indicate a path delay for each path. Each path may have a path power which is above a threshold power (p_{threshold}). In some embodiments, the WTRU may receive p_{threshold} from the wireless network to determine the delay profile based on the power delay profile.

In another example, the CIR the WTRU reports to the wireless network may be defined by a (e.g., configured) number of samples (e.g., N number of samples) where the WTRU is configured with a granularity of samples (e.g., X seconds apart). The WTRU may report samples corresponding to RSRPs over a configured RSRP threshold or samples corresponding to an M highest RSRPs among the samples. The WTRU may indicate locations or sample indices of samples where the WTRU measures the M highest RSRP samples. The first sample may be defined as the earliest arriving path, e.g., the first path. The WTRU may report timing, phase, and/or power information per sample.

In one example, the WTRU may receive an indication from the wireless network on how to generate CIR, PDP, or DP based on timing, phase, and/or power measurements. In some embodiments, the WTRU may send a request to the wireless network to then receive, from the wireless network, an indication of which methodologies to use to generate CIR, PDP, or DP based on the measurements performed by the WTRU. For example, the WTRU may receive a message from the wireless network (e.g., via LPP, RRC, MAC-CE, or DCI), the message indicating the DL-RS resource indices and associated measurement types (e.g., RSTD, AoA) to use to generate CIRs, PDPs or DPs. In some embodiments, the WTRU may receive, from the wireless network, an indication indicating the DL-RS resource indices and associated measurement types (e.g., RSTD, AoA) to generate CIRs, PDPs, or DPs.

In some embodiments, the WTRU may receive one or more of (1) a threshold (e.g., a power threshold) and (2) a timing range (e.g., 0 μs to 1 μs) and a timing granularity (e.g., every 0.1 μs in the indicated timing range, or 100 sample points in the indicated timing range) of CIRs, PDPs and/or DPs. In such embodiments, the WTRU may determine to report power and timing (e.g., relative timing compared to a reference timing, or absolute timing) of any samples whose corresponding received power is greater than the threshold (e.g., p_{threshold}).

The WTRU may send measurements in a report to the wireless network (e.g., LMF or gNB) via a semi-static message (e.g., LPP or RRC) or a dynamic message (e.g., UCI or UL MAC-CE). In the examples discussed herein, DL-RS (e.g., CSI-RS, DM-RS, and TRS) and SSB may be used interchangeably.

In examples provided herein, measurements and/or reporting of measurements may refer to actual measurements and/or other suitable, associated, quantities. Such quantities may include post-processed measurements and/or a determined characterization thereof (e.g., a timing, signal processing window, number of samples, or any other suitable characterization).

### Overview

The WTRU may determine a condition indicator based on a target-side condition or a WTRU-side condition. In some embodiments, the WTRU may determine to report measurements made on the received DL-RSs based on the determined condition indicator. In some embodiments, the WTRU may receive a request, from the wireless network (e.g., LMF or gNB), to report measurements for the received DL-RSs. The wireless network may process the measurements to determine the location of a sensing target (e.g., a car, a drone, a human, an automated guided vehicle, or an environmental object). In some embodiments, the WTRU may receive a request to report at least timing measurements, power measurements and/or phase measurements for the configured DL-RS the WTRU receives from a TRP. Each of the measurements (e.g., timing measurements, power measurements, or phase measurements) may be defined relative to a reference value (e.g., a reference timing, reference power, or reference phase). For example, the timing measurement may be timing relative to a reference timing (e.g., the first path, the earliest DL-RS, the first detected path or the first detected DL-RS). In another example, power measurements may be defined relative to a reference power (e.g., power of the first detected path). In some embodiments, phase measurements may be defined relative to a reference phase (e.g., phase of the first detected path).

In some embodiments, the WTRU may receive a request to make measurements and report the measurements for sensing purposes. In response to receiving the request, the WTRU may send a response to the wireless network, either accepting or rejecting the request. Furthermore, the WTRU may send a cause for the response when rejecting the request (e.g., the WTRU is mobile or the WTRU's battery power is low).

FIG. 2 shows an illustrative graph of example CIR estimate 200, in accordance with one or more embodiments of the present disclosure. In some embodiments, the WTRU may obtain a CIR estimate 200 for the received OFDM symbol. The CIR estimate 200 shown in FIG. 2 includes seven samples (e.g., first sample 202, second sample 204, third sample 206, fourth sample 208, fifth sample 210, sixth sample 212, and seventh sample 214). The WTRU may receive, from the wireless network, the number of samples for CIR estimates (e.g., CIR estimate 200). The WTRU may report measurements (e.g., timing, power, or phase) or measurements per sample when the measurements (e.g., RSRP) corresponding to the sample (e.g., first sample 202, second sample 204, third sample 206, fourth sample 208, fifth sample 210, sixth sample 212, and seventh sample 214) is above a (e.g., configured) threshold.

The WTRU may receive a request from the wireless network to report the CIR estimate 200. In some embodiments, the WTRU may report one or more samples corresponding to at least one measurement (e.g., received power) is above a threshold (p_{threshold}). The WTRU may indicate measurements (e.g., power, phase) and relative timing of the sample (e.g., first sample 202, second sample 204, third sample 206, fourth sample 208, fifth sample 210, sixth sample 212, and seventh sample 214) with respect to a reference timing. In some embodiments, the WTRU may report an OFDM symbol index at which the CIR estimate 200 is obtained. In addition, a slot index, a frame index, a subframe index and/or a SFN which includes the OFDM symbol may be reported by the WTRU. The WTRU may determine to report an average of the CIR estimates (e.g., including CIR estimate 200). In such embodiments, the WTRU may report, to the wireless network, the number of OFDM symbols used to determine the average of the CIR estimates. In addition, the WTRU may report a location of the OFDM symbols (e.g., symbol index, slot index, frame index, subframe index, SFN) used to determine the average CIR.

In some embodiments, the WTRU may receive a request to report N CIR estimates (e.g., CIR estimate 200) within a configured duration (e.g., one slot). In such embodiments, the WTRU may determine a CIR estimate (e.g., CIR estimate 200) per OFDM in the configured duration. The WTRU may determine to report N number of the CIR estimates (e.g., CIR estimate 200) based on a criterion (e.g., CIR estimates corresponding to the N highest RSRP).

In addition to the measurement, the WTRU may report the corresponding sample index for the measurement (e.g., a sample index corresponding to one of the first sample 202, second sample 204, third sample 206, fourth sample 208, fifth sample 210, sixth sample 212, and seventh sample 214). In one example, the WTRU may receive an indication to use an earliest sample as the reference timing (e.g., first sample 202 as shown in FIG. 1). In another example, the WTRU may receive a request to use the sample corresponding to the highest power as the reference timing (e.g., second sample 204 in FIG. 1). The WTRU may receive a time or sample offset, e.g., N_{offset}, to indicate the sensing target timing. For example, when N_{offset}=4 samples from the reference timing of sample, if the sensing target sample is second sample 204, the sensing target sample is sixth sample 202. In some embodiments, the WTRU may receive more than one time or sample offsets (e.g., N_{offset}), indicating a range of sensing target timing/samples or more than one sensing target timing or samples. For example, N_{offset}=[4,6] indicates sensing target samples that are 4, 5 and 6 samples from the reference timing or sample. In such an example, the WTRU may determine to make measurements (e.g., timing measurement, power measurement, or phase measurement) for the indicated range of samples or one or more sensing target timing/samples.

Although the examples herein use OFDM symbols, the present disclosure is not limited to the use of OFDM symbols, and is applicable to any type of symbols, such as DFT-spread OFDM, or single carrier signals.

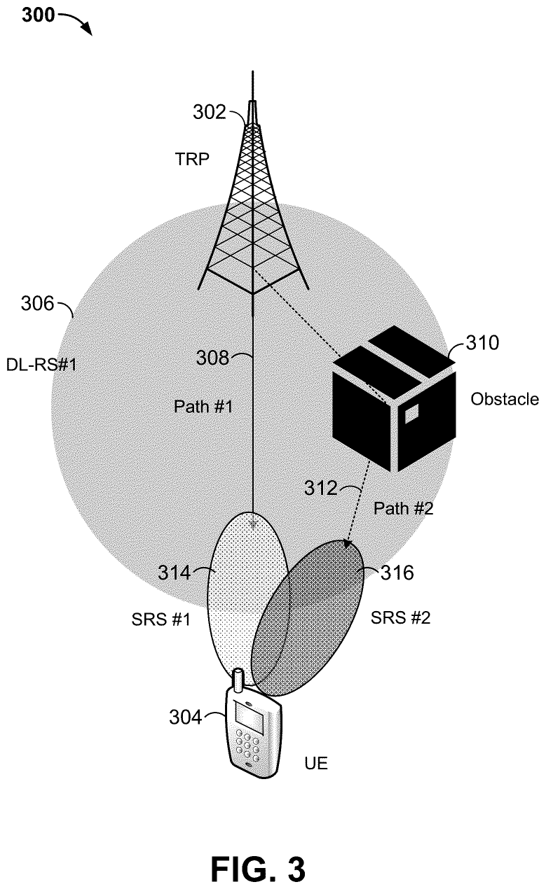

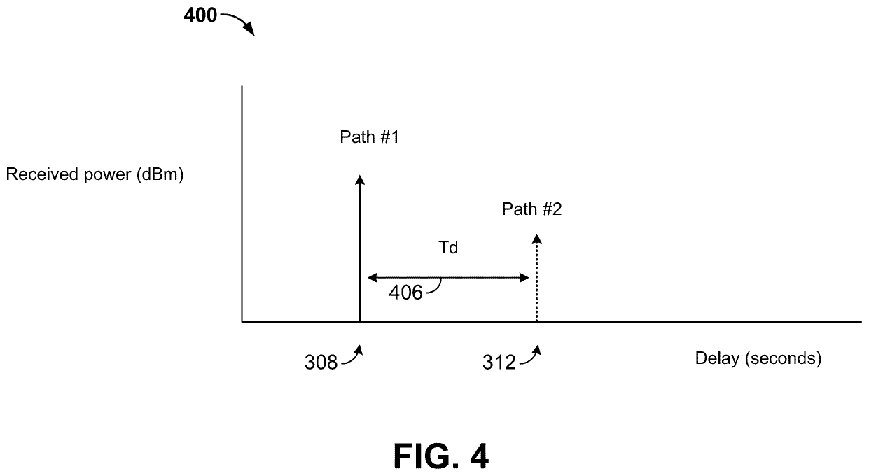

FIG. 3 shows an illustrative example of a multi-path channel 300 with WTRU 304 and wireless network (e.g., via TRP 302) showing a spatial relationship between a DL-RS 306 and an UL-RS that may be used within the communications system illustrated in FIG. 1A. Additionally, FIG. 4 shows an illustrative graph of an example multi-path delay profile 400 showing received power for direct path 308 and indirect path 312 of FIG. 3, in accordance with one or more embodiments of the present disclosure.

The WTRU 304 may receive DL-RS 306 from the TRP 302. As illustrated in FIG. 3, the transmitted signal may reflect against an obstacle 310 and creates an additional path (e.g., an indirect path 312). Therefore, the WTRU 304 receives two paths, direct path 308 and indirect path 312 where the indirect path 312 arrives T_{d} seconds (e.g., time difference 406) later than direct path 308. In some embodiments, the obstacle 310 that creates the indirect path 312 may be referred to as a “sensing target”. In some embodiments, the wireless network or WTRU 304 may determine the location of the obstacle 310 based on measurements (e.g., timing measurements, power measurements, and/or measurements).

In some examples, the WTRU 304 may receive a request, from the wireless network (e.g., LMF or gNB), to report measurements. The WTRU 304 may receive a request, from the wireless network, to associate measurement information to the RS and/or RS parameters (e.g., DL-RS parameters or UL-RS parameters). In some embodiments, the WTRU 304 may receive a request to associate a type of measurement to the RS (e.g., angle measurement to the RS). For example, the WTRU 304 may determine to associate an AoA of the received DL-RS to the AoD of an UL-RS.

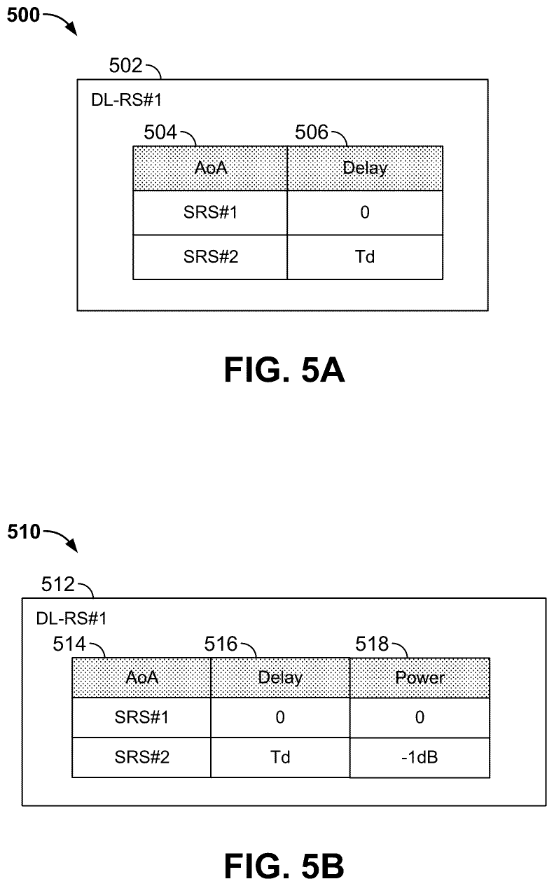

FIGS. 5A-B show examples of WTRU report content (e.g., 500 and 510), in accordance with one or more embodiments of the present disclosure. Examples of measurement reports (e.g., 502 and 512) that the WTRU sends to the wireless network is shown in FIGS. 4 and 5. The WTRU may report AoA (e.g., AoA 504 and AoA 514) and timing information (e.g., delay 506 and delay 516) for each detected path. The AoA (e.g., AoA 504 and AoA 514) may be reported in terms of UL-RS (e.g., SRS) configured to the WTRU, implying that the measured AoA (e.g., AoA 504 and AoA 514) is similar to or equivalent to an AoD of the indicated SRS (e.g., first SRS 314 or second SRS 316, as shown in FIG. 3). In some embodiments, the direct path 308 is aligned with AoD of the first SRS 314 and the indirect path 312 is aligned with AoD of the second SRS 316. As shown in FIGS. 3 and 5A-B, “SRS #1” and “SRS #2” indicate identification of the SRSs (e.g., first SRS 314 and second SRS 316) transmitted by the WTRU 304. In some embodiments, the SRSs (e.g., first SRS 314 and second SRS 316) may be indicated as identification information in the configuration, e.g., using SRS resource index or SRS ID. Using the reports (e.g., reports 502 and 512), the WTRU 304 may report to the wireless network that the indirect path 312 arrives T_{d} seconds later than the direct path 308. In some embodiments, WTRU 304 may determine to associate an SRS (e.g., first SRS 314 or second SRS 316) and DL-RS based on a spatial filter used to transmit or receive the SRS or DL-RS, respectively. For example, WTRU 304 may use the same or a similar spatial filter to transmit the SRS or receive the DL-RS.

As shown in FIG. 5B, the WTRU may report AoA 514, timing information (e.g., delay 516) and power information 518 for each detected path (e.g., first SRS 314 and second SRS 316). In embodiments where there are two or more paths (e.g., two or more SRSs), the WTRU reports timing information (e.g., delay 516) and power information 518 relative to a reference timing and reference power. In some embodiments, the reference timing and reference power are associated with the direct path 308. For example, as shown in FIG. 5B, the power received for the indirect 312 path is 1 dB less than the power received for the direct path 308. In some examples, the measurement report (e.g., measurement reports 502 and 512) may be referred to as a “power-delay-spatial” report.

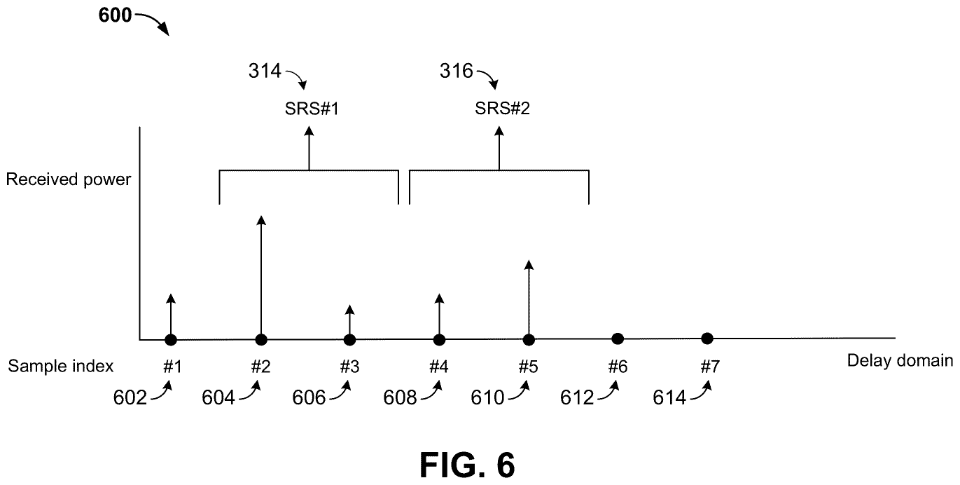

FIG. 6 shows an illustrative graph 600 of example paths associated to sample-based measurements, in accordance with one or more embodiments of the present disclosure. In one example, the WTRU may determine to associate UL-RS information to one or more samples (e.g., first sample 602, second sample 604, third sample 606, fourth sample 608, fifth sample 610, sixth sample 612, and seventh sample 614) in the sampled based measurement report. For example, the WTRU may be configured to report RSRP per sample, where the first sample 602 may be the first detected path from the received DL-RS. In some embodiments, the WTRU may associate or indicate a respective AoA for each sample of the samples or a set of samples with an RSRP that is greater than a configured power threshold. For example, as shown in FIG. 6, the WTRU may indicate one or more samples, each of which have a respective AoA that corresponds to an AoD of the configured UL-RS (e.g., first SRS 314 for the AoA of second sample 604 and third sample 606, or second SRS 316 for the AoA of fourth sample 608 and fifth sample 610). Although each of first SRS 314 and second SRS 316 each include two samples, an SRS may include one sample or more than two samples.

The WTRU may determine to indicate, to the wireless network, a change in a reference SRS in the measurement report. For example, the reference SRS may be used to determine relative timing, relative power or relative phase measurement for other SRSs included in the measurement report. In some embodiments, the WTRU may report the reference SRS when the WTRU determines to use a new reference SRS (e.g., a DL-RS used to determine relative measurements for timing, power, and phase). The WTRU may further report the sample index or path index corresponding to each relative timing measurement, relative power measurement, or relative phase measurement. In one example, the WTRU may be configured to report any association between a previous reference SRS and a new reference SRS to the wireless network. An example of an association may be any measurement offset or difference in the respective measurement of the new reference SRS compared to the old reference SRS. For instance, the WTRU may determine a first path (e.g., LoS path) as an old reference for relative timing measurement and a second path as a new reference for timing measurement. The association between the references may be relative timing of the new reference with respect to the old reference.

In some embodiments, the WTRU may be configured to change the reference (e.g., SRS reference) and/or report the measurements (e.g., only) when the WTRU determines an association between the old reference (e.g., previous reference SRS) and the new reference (e.g., new reference SRS). The association may enable the wireless network or the WTRU to use measurements with each of the old reference and the new reference for sensing. In some embodiments, WTRU may be configured to terminate any performance of sensing if the WTRU cannot determine an association between the new reference (e.g., new reference SRS) and the old reference (e.g., previous reference SRS).

The WTRU may be configured to transmit a report including at least one of the following to the wireless network: (a) one or more measurements (e.g., associated with a new reference SRS), (b) an indication (e.g., binary flag) of whether the reference (e.g., reference SRS) has changed when compared to a previous measurement report, (c) a new reference (e.g., a new reference SRS), (d) an old reference (e.g., a previous reference SRS), or (e) an offset or difference between the new reference and old reference (e.g., a measurement of new reference SRS relative to the old reference SRS), or a combination thereof.

In some embodiments, the WTRU may determine to send a WTRU capability report to the wireless network based on a request from the wireless network or as a part of initial access procedure. The WTRU capability report may include at least one of the following: (1) an indication that the WTRU is a stationary device (e.g., a device that accesses power from an electric outlet) or a mobile device (e.g., a handset or device that is attached to a mobile object such as a car or drone), (2) a capability of the WTRU to perform measurements on specific types of signals or DL-RSs (e.g., SSB, CSI-RS, DM-RS, PRS, TRS, PTRS), (3) a capability of the WTRU to perform measurements periodically and a measurement periodicity (e.g., 1 ms), (4) a capability of the WTRU to report to the wireless network periodically and a measurement report periodicity (e.g., 1 ms), (5) a capability of the WTRU to perform measurements and transmit reports that contain the measurements, (6) a capability of the WTRU to perform sensing-related measurements and transmitting measurement reports that contain sensing-related measurements, (7) a capability of the WTRU to perform sensing and communication, (8) WTRU location information and a method to determine the WTRU location information (e.g., WTRU location information determined based on GNSS or a RAT dependent position), (9) an equipped hardware (e.g., camera, infrared sensors, heat sensors, thermometer, gyroscope, or speed sensor) at the WTRU for sensing purposes or for purposes of measuring the WTRU status, or (10) a supported sensing type, which may include one or more of: (a) a sensing accuracy (e.g., a maximum accuracy or a minimum accuracy, and/or a measurement granularity), (b) a sensing use case (e.g., detection, tracking), (c) a sensing measurement with or without WTRU location information, (d) a number of sensing measurement resources that the WTRU can perform simultaneously, or (e) an indication of whether the WTRU supports simultaneous sensing measurement and communication at a same frequency or different frequency.

After the WTRU transmits the WTRU capability report, the WTRU may receive a request for sensing (e.g., to report measurements to the wireless network) from the wireless network. The WTRU may send a response to the request for sensing to the wireless network. If the WTRU accepts the request, the WTRU may receive sensing information configurations for performing measurements of RSs (e.g., DL-RSs). In some embodiments, the WTRU may determine to generate a measurement report if one or more trigger condition for the measurement reporting is satisfied.

In some embodiments, the WTRU may receive a request from the wireless network (e.g., gNB or LMF) to report the WTRU location to the wireless network. For example, the WTRU may report the WTRU location using a RAT independent positioning method (e.g., GNSS) and/or a RAT dependent positioning method (e.g., DL-TDOA). The WTRU may indicate to the wireless network the positioning method used to determine the WTRU location. The WTRU may receive the request for the WTRU location before the WTRU reports sensing related measurements to the wireless network. In some embodiments, the WTRU may report the WTRU location after the WTRU receives the request to perform sensing related measurements. In the examples described herein, “measurements” and “sensing related measurements” may be used interchangeably.

### Measurement Condition Indicators

The WTRU may be configured to determine a condition indicator based on a measurement conditions (e.g., a WTRU condition or sensing target condition). Examples of WTRU conditions include (1) a change in WTRU position, a change in rate thereof (e.g., change in WTRU speed), a change in WTRU positioning method or a change in WTRU positioning accuracy above a (e.g., configured) threshold, (2) a change in WTRU orientation (e.g., the WTRU has been rotated about at least one spatial axis), (3) a change in positions of antenna panels of the WTRU, (4) a change in antennas (e.g., different number of antenna elements, or different polarization) or antenna panels of the WTRU, (5) a change in spatial filter used by the WTRU, (6) a change in hardware used by the WTRU (e.g., amplifiers, filters, or antenna), (7) a change in environment such as a blockage of LoS between the TRP and/or the sensing target (e.g., an obstacle or object the wireless network or WTRU is trying to locate), or a change in temperature, humidity or weather, (8) accidental or intentional incidents such as temporary (e.g., momentary) power outage, damage to the WTRU external hardware or internal hardware (e.g., a broken or bent antennas), tampered sensors (e.g., paint over cameras), tampered electronics (e.g., high level of noise, or hackers infiltrating electronics or control systems), (9) a change in noise level, (10) a change in sensing information configuration (e.g., a change in applicable sampling window size), or (11) a change in processing measurements (e.g., a number of samples for averaging measurements, a duration of the measurements for averaging), or a combination thereof. In some embodiments, the change in the environment may be detected by RAT independent methods (e.g., using cameras, temperature sensors, sensor, or sound sensors).

Examples of sensing target side conditions include (1) a change in relative WTRU position with respect to a reference location (e.g., a sensing target location), (2) a detection in movement of the sensing target (e.g., by detecting a change in its position, or estimate of sensing target velocity), (3) a change in orientation of the sensing target, (4) a detection of a change in a number of sensing targets (e.g., where the WTRU may initially detect one target, and after several measurements, the WTRU may detect more than one sensing targets), (5) a detection of an environmental object (e.g., objects other than the sensing target), (6) a change in the post-processing evaluation of the micro-Doppler (MD) signature for the sensing target (e.g., the WTRU determines, during an evaluation window, a probability for signature matching of a target MD profile has changed below (i.e., a likely mismatch) or above (i.e., a likely match) a configured threshold, or (7) a change in the post-processing evaluation of a radar cross section (RCS) for the sensing target (e.g., a WTRU determines, during the evaluation time, a probability for RCS matching of a target RCS profile has changed below (i.e., a likely mismatch) or above (i.e., a likely match) a configured threshold, or a combination thereof. One example realization related to the two aforementioned post-processing evaluation conditions may be based on two assumptions: (a) a sensor device may perform interim processing, such as to identify whether or not measurements to report are related to a living being (e.g., a human or animal using MD evaluation), or with more granularity to distinguish between a human and an dog (e.g., using RCS) evaluation, and (b) the wireless network sensing function may prioritize reporting from the sensor device that is for detecting a human.

The WTRU may be configured with a respective threshold to determine whether the WTRU should trigger a change in the corresponding condition. For example, the WTRU may be configured with an angle threshold (e.g., in degrees) or a distance threshold (e.g., in meters) to determine the condition indicator (e.g., a value of 1 indicating a change in condition of the WTRU or sensing target, and a value of 0 indicating no change in condition).

In some embodiments, the WTRU may determine to report information regarding the change in condition of the WTRU and/or sensing target. For example, the WTRU may report an amount of rotation of the WTRU (e.g., a change in WTRU orientation). In another example, the WTRU may report an incident (e.g., a power outage) to the wireless network. The WTRU may report the information regarding the change in condition in the measurement report or in a separate report. In some embodiments, the WTRU may receive a request from the wireless network to report the information regarding the change in condition of the WTRU and/or sensing target.

In some embodiments, a WTRU may activate the condition indicator upon receiving a DL message or DL signal from the wireless network. For example, the wireless network may transmit a request for a respective WTRU to send a condition indicator, via a system information block (SIB) and/or RRC dedicated message and/or via non-access stratum (NAS) signaling, to one or more WTRUs. In some embodiments, a wireless network may transmit, to one or more WTRUs associated with a geographical location or geographical zone, a request for a respective WTRU to send a condition indicator. For example, a WTRU may be pre-configured to activate the reporting of condition indicators when the WTRU location is within one of the (e.g., defined) areas or zones.

In some embodiments, a WTRU may be configured to activate (e.g., determining and reporting), using an implicit method, the condition indicator upon receiving at least one of the sensing signals (e.g., DL-RS, SSB index). For example, the WTRU may activate to determine and report the condition indicator upon receiving at least one sensing signal and/or with performing sensing measurement. In some embodiments, a wireless network may transmit a request of sending a condition indicator activation signal (e.g., a DCI, MAC CE, LPP, or RRC message) using an explicit method. For example, upon receiving the request for a condition indicator, the WTRU may activate, via an explicit method, to determine and report the condition indicator to the wireless network according to the determined conditions of the WTRU and/or the sensing target. The WTRU may determine and report a reference point (e.g., a reference condition) for determining the value of the condition indicator. For example, the WTRU may determine the change in the measurement condition (e.g., condition of the WTRU and/or sensing target) by comparing a current measurement condition to a measurement condition of at least one of the following occasions: (a) a last occasion at which the WTRU reported measurements to the wireless network, (b) a last occasion at which the WTRU determined its measurement condition, (c) a last occasion at which the WTRU received a request to determine the measurement condition, or (d) a last occasion at which the WTRU performed measurements on the received DL-RS. In some embodiments, the WTRU may be configured, by the wireless network, with the reference point (e.g., a last measurement occasion or last reporting occasion). An occasion may be defined as an instance of time at which the WTRU (a) performs measurements on the received DL-RS, (b) reports measurements to the wireless network or (c) determines a condition of the WTRU or sensing target, for example.

The WTRU may determine a measurement condition or a change in the measurement condition based on at least one of (1) determining whether a change in measurement condition is above a (e.g., configured) threshold (e.g., the WTRU moved more than a preconfigured distance threshold), (2) whether the WTRU receives a request to determine the condition of the WTRU and/or a change in the measurement condition compared to an indicated reference point (e.g., a last occasion the WTRU received a request to determine the measurement condition), (3) whether the WTRU is configured to determine measurement conditions periodically, at a (e.g., configured) periodicity, or (4) a (e.g., preconfigured) time before a configured or indicated reference point (e.g., a time before transmission of the configured or indicated UL-RS), or a combination thereof. In some embodiments, the WTRU may receive a request from the wireless network to determine a specific condition of the WTRU (e.g., WTRU orientation or rotation). In some embodiments, the WTRU may be configured to stop reporting the condition indicator if the WTRU is configured with a duration or time window during which the WTRU determines the condition of the WTRU or sensing target. In such embodiments, when the duration or time window expires, the WTRU may determine to stop reporting the condition indicator to the wireless network. The duration or time window may be configured semi-statically (e.g., via RRC, LPP), or dynamically (e.g., via DCI, MAC-CE) by the wireless network. In some embodiments, the WTRU may receive one or more activation or deactivation commands from the wireless network to activate or deactivate the determination and reporting of the conditions of the WTRU and/or sensing. The WTRU may receive the activation or deactivation command from the wireless network via MAC-CE. In some embodiments, the WTRU may receive an initiation message (e.g., via LPP, RRC) from the wireless network to start the reporting of the conditions of the WTRU or sensing target to the wireless network. In some embodiments, the WTRU may receive a termination message (e.g., via LPP, RRC) from the wireless network to stop the reporting of the conditions of the WTRU or sensing target to the wireless network

In some embodiments, the condition indicator may represent a state of the condition or a change in the condition. For example, the WTRU may be configured with more than one values of a condition indicator where each value is associated with a different state of the condition. For example, a distance the WTRU moved from a last occasion may be associated with a respective value (e.g., corresponding to a respective state). The WTRU may be configured with one or more threshold ranges (e.g., 0 to 1 meter, 1 meter to 2 meters, etc.) where each threshold range is associated with a value (e.g., 0 for 0 to 1 meter, 1 for 1 meter to 2 meters, etc.). In some embodiments, the WTRU may be configured with more than one state of the condition, where each state represents a respective change in the condition (e.g., a respective amount of distance the WTRU moved, or a respective amount of rotation the WTRU has been rotated).

In another example, the WTRU may indicate, using the condition indicator, whether the sensing target is stationary or mobile. The WTRU may report the condition indicator of “0” if the WTRU determines that the sensing target is stationary. Furthermore, when the WTRU determines that the sensing target is mobile or has moved since the last occasion, the WTRU may report, to the wireless network, the condition indicator of “1”.

In some embodiments, the WTRU may report to the wireless network whether the methods for collecting or performing measurements (e.g., how requested statistics are calculated, or how a condition or amount of data used to calculate the requested statistics) have changed since the last occasion. For example, the WTRU may receive a request to report, to the wireless network, processed measurements (e.g., a mean, and/or standard deviation). If the WTRU changes the method of processing (e.g., change a number of samples for determining the mean of the measurements, or the mean is calculated based on a weighted average instead of based on an unweighted average), the WTRU may indicate to the wireless network that the methodology of processing of measurements has changed. The WTRU may report the condition indicator (e.g., “0” indicating no change in condition, or “1” indicating a change in condition) to the wireless network to indicate one or more change to the measurements or processing methodology.

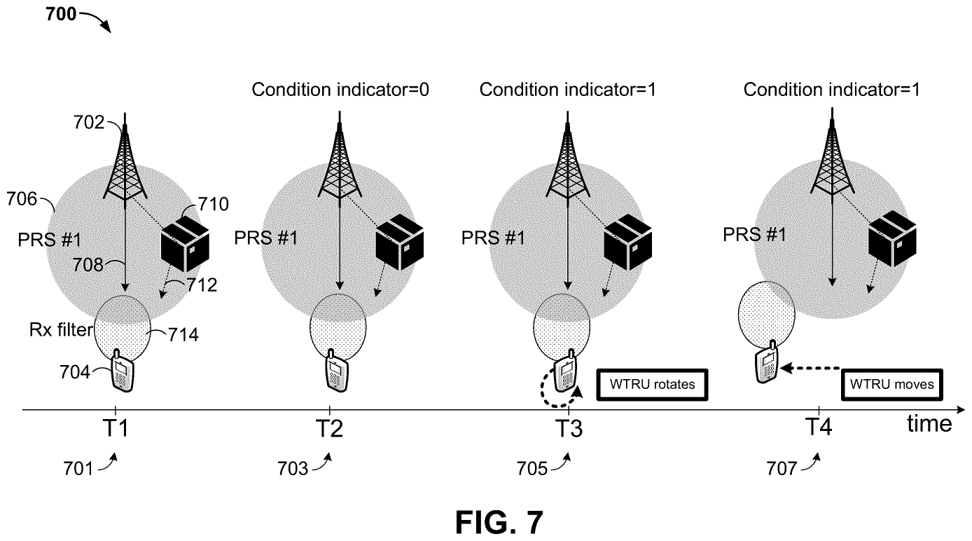

FIG. 7 shows an illustrative example of a WTRU 704 and wireless network (e.g., accessed via TRP 702) using a condition indicator over a time period (i.e., from T₁ 701 to T₄ 707), in accordance with one or more embodiments of the present disclosure. In some embodiments, the value of the condition indicator may indicate whether there was a change in a condition of the WTRU 704 and/or sensing target compared to the condition at a reference timing. For example, the WTRU 704 may assign a value of “1” to the condition indicator when there is a change in a condition of the WTRU 704 compared to the last occasion the WTRU 704 determined the condition. The WTRU 704 may assign a value of “0” to the condition indicator when there is no change to in the condition of the WTRU 704, or when the WTRU 704 determines that the change in the condition is less than a (e.g., configured) threshold value. In another example, the condition indicator may not be explicitly associated with any conditions, but rather the WTRU 704 determines any change to a condition of the WTRU 704 since the last occasion. The WTRU 704 may report to the wireless network, based on the WTRU's determination of whether there was any change to the WTRU condition or not. One example is illustrated in FIG. 7, where the WTRU 704 is configured to determine the condition indicator on each occasion. At time T₁ 701, the WTRU 704 does not determine the condition indicator since it is the first timing occasion. At time T₂ 703, the WTRU 704 determines that the condition of the WTRU has not changed since time T₁ 701, and thus the WTRU 704 determines that the condition indicator is “0”, indicating no change in the condition. As shown in FIG. 7, at some point between time T₂ 703 and time T₃ 705, the WTRU 704 rotates more than a (e.g., configured) threshold and, at time T₃ 705, the WTRU 704 determines that the condition of the WTRU 704 changed since the previous occasion (e.g., time T₂ 703). Therefore, at time T₃ 705, the WTRU 704 determines that the condition indicator is “1”, indicating that there was a change in the condition of the WTRU 704 compared to the condition at time T₂ 703. Furthermore, between time T₃ 705 and time T₄ 707, the WTRU 704 moves a distance which is greater than a (e.g., configured) threshold, and therefore, at time T₄ 707, the WTRU 704 determines that the condition indicator is “1”.

In some embodiments, the change in a condition of the WTRU 704 or sensing target (e.g., obstacle 710) may not be restricted to a change in the condition at two different timing instances. The change in condition may occur between two time instances and the WTRU may determine that there was a change in the condition during that time. For example, between time T₁ 701 and time T₂ 703, the WTRU 704 may move to another location and then back such that the WTRU 704 is located at the same WTRU location at time T₁ 701 and time T₂ 703. In such an example, if the WTRU 704 moved more than the configured distance threshold, the WTRU 704 may determine that the condition of the WTRU 704 has changed.

In some embodiments, the timing instances at which the WTRU 704 determines the condition of the WTRU 704 and/or sensing target (e.g., obstacle 710) may be aligned with the timing instances the WTRU 704 performs measurements. In some embodiments, the timing instances at which the WTRU 704 determines the condition of the WTRU 704 and/or the sensing target (e.g., obstacle 710) may not be aligned with the timing instances the WTRU 704 performs measurements.

In another example, the condition indicator may be associated with one or more condition of the WTRU 704 (e.g., WTRU location and WTRU orientation). The WTRU 704 may be configured to receive configurations indicating a condition indicator is associated to two or more conditions of the WTRU 704. In some embodiments, the WTRU 704 may receive, from the wireless network (via TRP 702), one or more thresholds for the WTRU 704 to determine the condition indicators. In some embodiments, the WTRU 704 may determine not to include the condition indicator in the measurement report if the change in the condition of the WTRU 704 or sensing target is below the (e.g., configured) threshold.

In another example, the WTRU 704 may (e.g., explicitly) indicate, to the wireless network, an amount of the change in the condition of the WTRU 704. For example, the WTRU 704 may indicate the amount of change in WTRU location or WTRU rotation. In some embodiments, the WTRU 704 may report to the wireless network, accidents or incidents (e.g., power outage, hacked systems) that have occurred since the last timing occasion. In some embodiments, the WTRU 704 may be configured, by the wireless network, with events (e.g., WTRU movement, power outage) to report. Once configured with the events, the WTRU 704 may determine whether any of the configured events have occurred and report the determined event to the wireless network, along with the corresponding amount of change to a condition.

In some embodiments, the WTRU 704 may receive a request to report the condition indicator associated with the indicated measurement conditions. The WTRU 704 may determine the measurement condition or change in the measurement condition and report the associated condition indicator to the wireless network. In some embodiments, the condition indicator may be associated to measurements (e.g., timing, power) in the measurement report. The condition indicator may be associated with a specific type of measurements in the measurement report (e.g., timing) to indicate the type of condition that has changed. For example, the WTRU 704 may determine to associate the condition indicator with power measurements to indicate that the orientation of the WTRU 704 has changed since the last occasion (e.g., last measurement occasion). In another example, the WTRU 704 may determine to associate a condition indicator with timing measurements (e.g., delay) to indicate that the hardware of the WTRU 704 has changed since the last occasion (e.g., last measurement occasion). In some examples, the WTRU 704 may determine to associate a condition indicator with more than one sensing targets (e.g., obstacle 710). The WTRU 704 may receive a request from the network to associate a condition indicator to one or more sensing target (e.g., obstacle 710). For example, the WTRU 704 may determine to associate the condition indicator to indicate conditions of the WTRU 704 to the wireless network. The WTRU 704 may include the condition indicator in the measurement report if the measurements correspond to more than one sensing target (e.g., obstacle 710). In other examples, the WTRU 704 may receive a request from the wireless network to associate a condition indicator to one sensing target (e.g., obstacle 710). In some embodiments, the WTRU 704 may include the condition indicator to indicate a change in conditions of the WTRU 704 and/or the sensing target (e.g., obstacle 710) in the measurement report.

In some embodiments, each of the sensing targets (e.g., obstacle 710) may be associated with DL-RSs and/or UL-RSs. For example, the WTRU may receive one or more configuration or indications from the wireless network, indicating with which DL-RSs and/or UL-RSs each sensing target (e.g., obstacle 710) is associated. An association between the sensing target (e.g., obstacle 710) and DL-RSs and/or UL-RSs may imply that the WTRU may perform measurements (e.g., multi-path measurements) which contain characteristics of the sensing target (e.g., a path in the multipath measurement that corresponds to a reflected path off of the sensing target, such as indirect path 712). In some embodiments, the WTRU 704 may determine to associate the condition indicator with the DL-RSs with which the sensing target (e.g., obstacle 710) is associated. In such embodiments, the condition indicator may correspond to conditions of the WTRU 704 or the sensing target (e.g., obstacle 710). For example, the WTRU may determine to associate the condition indicator with the measurements obtained from the DL-RSs with which the sensing target (e.g., obstacle 710) is associated. In some embodiments, the WTRU 704 may be configured with DL-RSs associated with more than one sensing target (e.g., obstacle 710). In some embodiments, the WTRU 704 may receive a request to associate a condition indicator to one or more DL-RSs (e.g., using DL-RS resource IDs). In one example, the WTRU 704 may determine to associate one condition indicator to one DL-RS (e.g., PRS), indicating that the DL-RS is associated with one sensing target. In some embodiments, if the measurements performed for one or more DL-RSs (e.g., a first set of DL-RSs) are associated with one sensing target, the WTRU 704 may determine to associate one condition indicator to the first set of DL-RSs. An example of measurements associated with one sensing target is when the timing measurements made from different DL-RSs include a reflected path associated with the same sensing target.

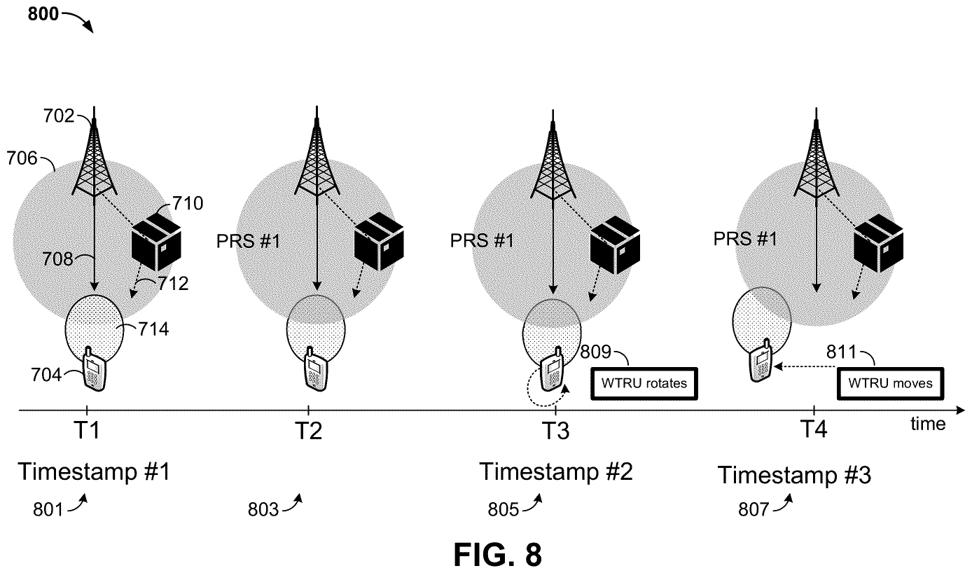

FIG. 8 shows an illustrative example of a WTRU 704 and wireless network (e.g., accessed via TRP 702) using timestamps to indicate a change in a condition of the WTRU 704 or sensing target (e.g., obstacle 710), in accordance with one or more embodiments of the present disclosure. In some embodiments, the WTRU 704 may include a timestamp in the measurement report. The timestamp may indicate the time at which the measurements are performed and/or the time at which the WTRU 704 reported the measurements to the wireless network. In one example, the timestamp may be included in the measurement report to indicate a change in conditions of the WTRU 704 and/or sensing target (e.g., obstacle 710). In some embodiments, the WTRU 704 may not include a timestamp in the measurement report if the WTRU 704 does not determine a change in conditions (e.g., the condition is the same as the reference point, or the last occasion the WTRU performed measurements). The WTRU 704 may determine to include the timestamp in the measurement report if the WTRU 704 determines the condition has not been reported in the past. In some embodiments, the WTRU 704 may include a timestamp when the condition changes compared to the reference point (e.g., when condition indicator is “1”). For example, as shown in FIG. 8, the WTRU generates timestamp #1 at time T₁ 801 and includes timestamp #1 in the measurement report as it is the first measurement the WTRU 704 performs. The WTRU may not generate a timestamp at time T₂ 803 as the conditions of the WTRU 704 and sensing target (e.g., obstacle 719) remained unchanged when compared to the conditions at time T₁ 801. At time T₃ 805, the WTRU 704 determines a change in the condition of the WTRU 704 (i.e., the WTRU 704 has changed orientation), and therefore the WTRU generates timestamp #2 and reports the timestamp to the wireless network. At time T₄ 807, the WTRU determines a change in the condition of the WTRU 704 (i.e., the WTRU 704 has moved), and there the WTRU 704 generates timestamp #3 and reports the timestamp to the wireless network. In some embodiments, the WTRU 704 may receive configurations for a time window during which the WTRU 704 determines one or more conditions of the WTRU 704 and/or the sensing target (e.g., obstacle 710). In some embodiments, the WTRU 704 may compare the current condition of the WTRU 704 and sensing target with conditions determined during the time window and determine whether there is a change in the condition based on those comparisons. In some embodiments, the WTRU 704 may determine whether there is a change in the condition of the WTRU 704 or sensing target during the time window. The WTRU 704 may be configured to determine a change in the conditions between two occasions during the time window. In some embodiments, the WTRU 704 may determine to include a timestamp in the measurement report if the condition of the WTRU 704 and/or sensing target changes compared to the previous occasion (e.g., the most recent measurement occasion or reporting occasion). The timestamp may be associated to the measurements (e.g., timing, power) in the measurement report. In some embodiments, the timestamp may be associated with a specific type of measurements in the measurement report (e.g., timing) to indicate the condition that has changed. For example, the WTRU 704 may determine to associate the timestamp with power measurements to indicate that the orientation of the WTRU 704 changed (e.g., the WTRU 704 has been rotated). In some embodiments, the WTRU 704 may determine to include each of the condition indicator and the timestamp in the measurement report. The WTRU 704 may include the timestamp to indicate the time when (a) the measurements were performed or (b) the WTRU 704 reported the measurements. The WTRU 704 may determine to use the condition indicator to report any changes to the condition of the WTRU 704 or sensing targets. In another example, the WTRU 704 may include the timestamp in the measurement report to indicate when the WTRU 704 determines a condition of the WTRU 704 or sensing target changed. The WTRU 704 may determine to associate the timestamp with the condition indicator to indicate the timing of the occasion at which the change in the condition occurred. In some embodiments, the WTRU 704 may be configured with a granularity of timestamps (e.g., timestamps are to be expressed in seconds, minutes and/or hours).

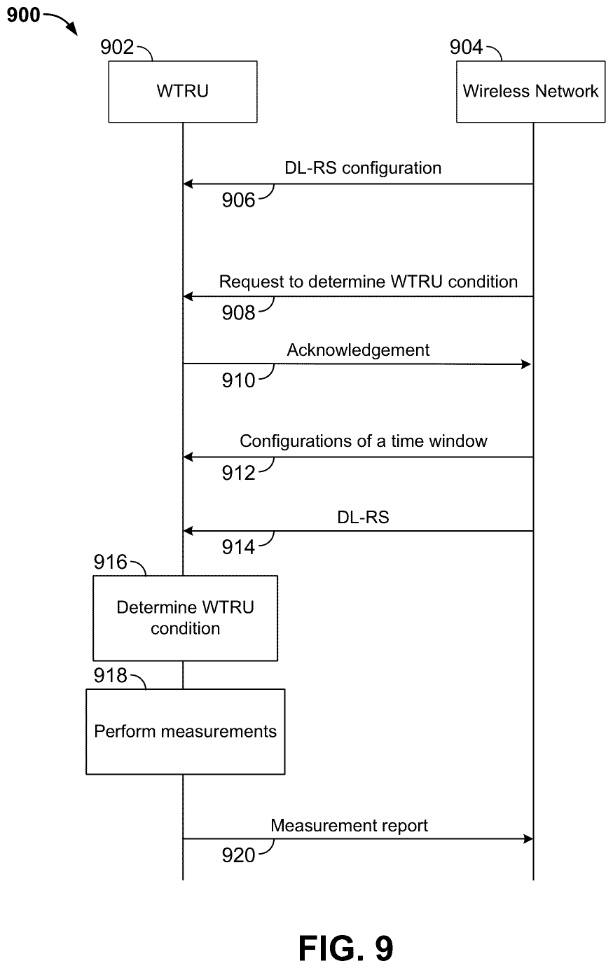

FIG. 9 shows an illustrative example of a WTRU 902 and a wireless network 904 (e.g., gNB, LMF) communicating messages that may be used within the communications system illustrated in FIG. 1A, in accordance with one or more embodiments of the present disclosure. At 906, the WTRU 902 receives DL-RS configurations from the wireless network 904. At 908, the WTRU 902 receives a request to determine one or more conditions of the WTRU 902. At 910, the WTRU 902 transmits an acknowledgement to the wireless network 904 (e.g., an acceptance or rejection in response to the received request at 908). At 912, if the WTRU 902 accepts the request to determine one or more conditions of the WTRU 902, the WTRU 902 receives configurations for a time window during which the WTRU 902 is configured to determine conditions of the WTRU 902. At 914, the WTRU 902 receives one or more DL-RSs from the wireless network 904. At 916, the WTRU 902 determines the conditions of the WTRU 902 during the configured time window. At 918, the WTRU 902 performs measurements on the received DL-RS. At 920, based on a condition indicator determined using the determined conditions of the WTRU 902, the WTRU 902 reports the measurements in a measurement report to the wireless network 904.

The examples explained herein may be applicable to inter-gNB signalling and respective gNB-gNB and gNB-CN Network Function (NF) interfaces for gNB-only and/or gNB-centric with WTRU 902 assistance (e.g., where the WTRU 902 reports measurements and/or assistance information to the wireless network 904) sensing deployments. An example of gNB-gNB sensing may be a transmission gNB transmitting reference signals to the sensing target and a reception gNB receiving the reflected reference signal from the sensing target. In gNB-mono static sensing, the gNB may transmit reference signals to the sensing target and perform measurements on the reflected signal. In the examples herein, “WTRU”, “gNB” and/or “TRP” may be used interchangeably.

### Reporting Using the Condition Indicator

In some embodiments, the WTRU may determine to report measurements based on the condition indicator. For example, if the measurement conditions do not change when compared to a previous measurement occasion, the WTRU may determine to report measurements to the wireless network. In some embodiments, when the WTRU determine that measurement conditions change when compared to the last occasion, the WTRU may not report measurements to the wireless network.

In one example, the WTRU may be configured to report condition indicator (e.g., “0” when WTRU determines no change in condition of WTRU) and therefore does not report the measurement results based on the condition indicator. When the measurement conditions do not change compared to a previous occasion or one or more pre-defined conditions, the WTRU may report the condition indicator using one or more of: (a) PUCCH, (b) a configured grant (e.g., SDT), (c) a dynamic grant, (d) a dedicated random access channel (RACH) preamble, (e) a RRC, or (f) a NAS message, or a combination thereof. For example, the WTRU may report the condition indicator with UL data and or UL control information when the WTRU performs a UL transmission for data and/or control signaling (e.g., via a scheduling request (SR), UCI, UL MAC CE, RRC message).

In some embodiments, the WTRU may report measurements and one or more condition indicators to the wireless network. For example, the WTRU may report the determined condition indicator with the measurement report. The measurement report may contain the determined condition indicator within the RRC message and/or NAS message for reporting measurement results.

In some embodiments, the WTRU may receive a request from the wireless network to perform measurements. The WTRU may determine to perform measurements until the WTRU determines that the condition of the WTRU and/or sensing target changes. The WTRU may be configured, by the wireless network, with a measurement window. The WTRU may determine to process (e.g., average) measurements made during the measurement window. In some embodiments, the WTRU may determine to terminate or pause the measurement window if the WTRU determines that one or more conditions of the WTRU and/or sensing target changes. In some embodiments, the WTRU may determine to restart the measurement window based on the condition of the WTRU and/or sensing target remaining unchanged for a (e.g., configured) number of instances or occasions (e.g., measurement occasions).

In some implementations, the WTRU may report, to the wireless network, whether the reported measurements are processed (e.g., averaged). The WTRU may determine to indicate a duration of time or a number of measurement occasions across which the measurements were processed. In some embodiments, the WTRU may implicitly indicate changes related to conditions of the WTRU and/or sensing target. In one example, the WTRU may implicitly indicate of the change in condition based on a (e.g., configured) selection of UL resources such as a selection of PRBs, power control feedback, UL-RS selection (e.g., SRS beam), or hybrid automatic repeat request (HARQ) timing behavior.

In some embodiments, the WTRU may be configured to refrain from sending sensing measurements based on a determination that the conditions of the WTRU and/or sensing target are changing. In some embodiments, the wireless network may (e.g., implicitly) determine a change in one or more conditions of the WTRU and/or sensing target if the WTRU fails to transmit sensing measurements.

In some embodiments, the WTRU may report measurements or assistance information to the wireless network to indicate (e.g., explicitly or implicitly) the change in one or more conditions of the WTRU and/or sensing target. In some embodiments, the WTRU may report measurements, or a status report associated with the detection of a change in a condition of the WTRU and/or sensing target. For example, the WTRU may report positioning related measurements (e.g., RSTD, time of arrival (ToA), AoA, or phase difference) to the wireless network if the WTRU moved more than the configured distance threshold. The WTRU may report an estimated velocity or information related to speed (e.g., Doppler frequency, micro-Doppler) of the movement of the WTRU if the WTRU detected movement of the WTRU or sensing target. In another example, the WTRU may report power status (e.g., remaining battery power or power ramping status) of the WTRU when the WTRU experiences an incident or other suitable event (e.g., a power outage). The WTRU may report an LOS status (e.g., hard or soft LOS indicator) to the wireless network when the WTRU detects a (e.g., temporary) blockage of LOS between the WTRU and (a) the TRP or (b) the sensing target. In some embodiments, the WTRU may determine to report rotation angles to the wireless network if the WTRU detects a rotation of the WTRU or any other suitable change in orientation of the WTRU. The WTRU may report hardware information to the wireless network if the hardware of the WTRU has changed (e.g., a change in a number of elements in the antenna, a change in orientation of antennas, a change in type of antennas, or a change in a number of antennas) during measurements. In some embodiments, the WTRU may report estimated characteristics of the sensing target and/or environmental object if the WTRU detects a new target (e.g., based on an RCS). The WTRU may report the measurements and/or assistance information to the wireless network with or without the condition indicator. In some embodiments, the WTRU may be configured to perform the measurements related to one or more conditions of the WTRU and/or sensing target during the (e.g., configured) measurement window. For example, the WTRU may be configured to determine assistance information (e.g., MD characteristics) during the configured measurement window.

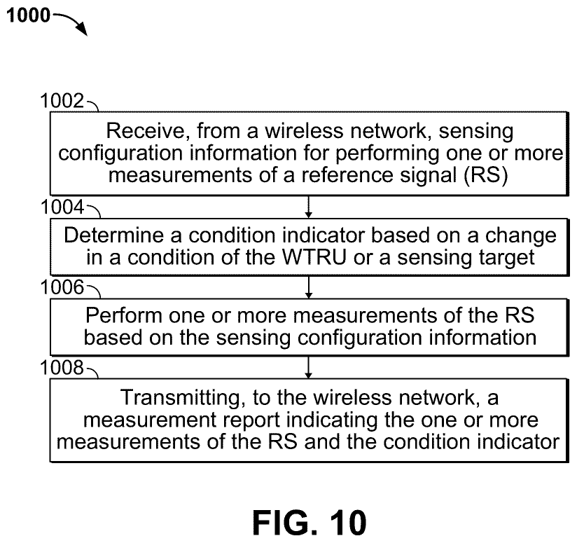

FIG. 10 shows a flowchart of a process 1000 performed by a WTRU (e.g., WTRUs 102a, 102b, 102c, 102d, and WTRU 304) for maintaining consistent sensing measurements, in accordance with one or more embodiments of the present disclosure.

At 1002, the WTRU receives, from a wireless network, sensing information for performing one or more measurements of a RS. In some embodiments, the WTRU may send a request to the wireless network for a configuration (e.g., DL-RS configurations, UL-RS configurations) in a PUSCH, PUCCH, UCI, MAC-CE, RRC or LPP message. The request from the WTRU may include configurations of a measurement gap, DL-RS processing window or window for transmission of UL-RSs. The WTRU may receive, from the wireless network (e.g., the LMF or gNB), SRS configurations (e.g., DL-RS and/or UL-RS configurations) to determine the position of the WTRU. The LMF may forward a PRS configuration and the SRS configurations to the gNB such that the gNB schedules PRS transmission or SRS reception at one or more of the TRP, TP, and RP. In some embodiments, the WTRU may receive configurations for a time window, which may include: (a) a duration (e.g., expressed in terms of seconds, number of symbols, number of slots, number of frames, or number of subframes), and (b) a start and/or end time (e.g., expressed in terms of absolute time, system time, relative time with respect to a reference time indicated by the wireless network or determined by the WTRU, SFN index, slot index, symbol index, frame index, or subframe index). In some embodiments, the WTRU may receive more than one configuration of a time window where each configuration is associated with an index.

At 1004, the WTRU determines a condition indicator based on a change in a condition of the WTRU or a sensing target (e.g., obstacle 310). Examples of a WTRU determining a condition indicator are shown in FIGS. 7 and 8. In some embodiments, the WTRU may be configured with a respective threshold to determine whether the WTRU should trigger a change in the corresponding condition. For example, the WTRU may be configured with an angle threshold (e.g., in degrees) or a distance threshold (e.g., in meters) to determine the condition indicator (e.g., a value of 1 indicating a change in condition of the WTRU or sensing target, and a value of 0 indicating no change in condition). The condition indicator may represent a state of the condition. For example, the WTRU may be configured with more than one values of a condition indicator where each value is associated with a different state of the condition. For example, a distance the WTRU moved from a last occasion may be associated with a respective value (e.g., corresponding to a respective state). The WTRU may be configured with one or more threshold ranges (e.g., 0 to 1 meter, 1 meter to 2 meters, etc.) where each threshold range is associated with a value (e.g., 0 for 0 to 1 meter, 1 for 1 meter to 2 meters, etc.). In another example, the WTRU may indicate, using the condition indicator, whether the sensing target is stationary or mobile. The WTRU may report the condition indicator of “0” if the WTRU determines that the sensing target is stationary. Furthermore, when the WTRU determines that the sensing target is mobile or has moved since the last occasion, the WTRU may report, to the wireless network, the condition indicator of “1”.

At 1006, the WTRU performs one or more measurements of the RS based on the sensing configuration information. In some embodiments, the WTRU may be configured to perform the measurements related to one or more conditions of the WTRU and/or sensing target during the (e.g., configured) measurement window. The WTRU may determine to perform measurements until the WTRU determines that the condition of the WTRU and/or sensing target changes. The WTRU may be configured, by the wireless network, with a measurement window.

At 1008, the WTRU transmits, to the wireless network, a measurement report indicating the one or more measurements of the RS and the condition indicator. Some example measurement reports 500, 510 are illustrated in FIGS. 5A-B. In some embodiments, the WTRU may report measurements or assistance information to the wireless network to indicate (e.g., explicitly or implicitly) the change in one or more conditions of the WTRU and/or sensing target. In some embodiments, the WTRU may report measurements, or a status report associated with the detection of a change in a condition of the WTRU and/or sensing target. For example, the WTRU may report positioning related measurements (e.g., RSTD, time of arrival (ToA), AoA, or phase difference) to the wireless network if the WTRU moved more than the configured distance threshold. The WTRU may report an estimated velocity or information related to speed (e.g., Doppler frequency, micro-Doppler) of the movement of the WTRU if the WTRU detected movement of the WTRU or sensing target. In another example, the WTRU may report power status (e.g., remaining battery power or power ramping status) of the WTRU when the WTRU experiences an incident or other suitable event (e.g., a power outage). The WTRU may report an LOS status (e.g., hard or soft LOS indicator) to the wireless network when the WTRU detects a (e.g., temporary) blockage of LOS between the WTRU and (a) the TRP or (b) the sensing target. In some embodiments, the WTRU may determine to report rotation angles to the wireless network if the WTRU detects a rotation of the WTRU or any other suitable change in orientation of the WTRU. The WTRU may report hardware information to the wireless network if the hardware of the WTRU has changed (e.g., a change in a number of elements in the antenna, a change in orientation of antennas, a change in type of antennas, or a change in a number of antennas) during measurements. In some embodiments, the WTRU may report estimated characteristics of the sensing target and/or environmental object if the WTRU detects a new target (e.g., based on an RCS). The WTRU may report the measurements and/or assistance information to the wireless network with or without the condition indicator. Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU), (ii) any of a number of embodiments of a WTRU, (iii) a wireless-capable and/or wired-capable (e.g., tetherable) device configured with, inter alia, some or all structures and functionality of a WTRU, (iii) a wireless-capable and/or wired-capable device configured with less than all structures and functionality of a WTRU, or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, or methods described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, sensing configuration information for performing one or more measurements of a reference signal (RS),
determining a condition indicator based on a change in a condition of the WTRU or a sensing target,
performing the one or more measurements of the RS based on the sensing configuration information, and
transmitting, to the wireless network, a measurement report indicating:
the one or more measurements of the RS, and
the condition indicator.

2. The method of claim 1, wherein the condition indicator is a bit value.

3. The method of claim 1, wherein determining the condition indicator comprises determining the condition indicator based on (1) a change in one or more first conditions of the WTRU or (2) a change in one or more second conditions of the sensing target.

4. The method of claim 1, wherein determining the condition indicator comprises detecting that (a) a position of the WTRU changed more than a configured threshold indicated in the sensing configuration information, (b) the WTRU moved out of a measurement area, or (c) the WTRU experienced a temporary power outage, or a combination thereof.

5. The method of claim 1, wherein determining the condition indicator comprises detecting (a) a change in a relative WTRU position with respect to a reference location, (b) a movement of the sensing target, or (c) a change in a post-processing evaluation of a signature for the sensing target, or a combination thereof.

6. The method of claim 1, wherein:
the RS is a downlink RS (DL-RS), and
the measurement report comprises a power-delay-spatial report comprising an association between the DL-RS and one or more uplink RSs (UL-RSs).

7. The method of claim 6, wherein the power-delay-spatial report comprises relative timings, relative power, and relative phase delay, when the association is between the DL-RS and two or more UL-RSs.

8. The method of claim 6, further comprising:
determining the association between the DL-RS and the one or more UL-RSs based on a comparison of an angle of arrival of the DL-RS to a respective angle of departure of each of the one or more UL-RSs.

9. The method of claim 1, further comprising receiving, from the wireless network, a request to determine the condition of the WTRU or the sensing target.

10. The method of claim 9, further comprising:
in response to the receiving the request to determine the condition of the WTRU or the sensing target, transmitting an acknowledgement to the wireless network.

11. A wireless transmit/receive unit (WTRU), comprising:
a processor; and
a transceiver coupled to the processor, wherein the WTRU is configured to:
receive, from a wireless network, sensing configuration information for performing one or more measurements of a reference signal (RS),
determine a condition indicator based on a change in a condition of the WTRU or a sensing target,
perform the one or more measurements of the RS based on the sensing configuration information, and
transmit, to the wireless network, a measurement report indicating:
the one or more measurements of the RS, and
the condition indicator.

12. The WTRU of claim 11, wherein the condition indicator is a bit value.

13. The WTRU of claim 11, wherein to determine the condition indicator the WTRU is configured to determine the condition indicator based on (1) a change in one or more first conditions of the WTRU or (2) a change in one or more second conditions of the sensing target.

14. The WTRU of claim 11, wherein to determine the condition indicator the WTRU is configured to detect that (a) a position of the WTRU changed more than a configured threshold indicated in the sensing configuration information, (b) the WTRU moved out of a measurement area, or (c) the WTRU experienced a temporary power outage, or a combination thereof.

15. The WTRU of claim 11, wherein to determine the condition indicator the WTRU is configured to detect (a) a change in a relative WTRU position with respect to a reference location, (b) a movement of the sensing target, or (c) a change in a post-processing evaluation of a signature for the sensing target, or a combination thereof.

16. The WTRU of claim 11, wherein:
the RS is a downlink RS (DL-RS), and
the measurement report comprises a power-delay-spatial report comprising an association between the DL-RS and one or more uplink RSs (UL-RSs).

17. The WTRU of claim 16, wherein the power-delay-spatial report comprises relative timings, relative power, and relative phase delay, when the association is between the DL-RS and two or more UL-RSs.

18. The WTRU of claim 16, wherein the WTRU is further configured to:
determining the association between the DL-RS and the one or more UL-RSs based on a comparison of an angle of arrival of the DL-RS to a respective angle of departure of each of the one or more UL-RSs.

19. The WTRU of claim 11, wherein the WTRU is further configured to receive, from the wireless network, a request to determine the condition of the WTRU or the sensing target.

20. The WTRU of claim 19, wherein the WTRU is further configured to, in response to receiving the request to determine the condition of the WTRU or the sensing target, transmit an acknowledgement to the wireless network.
